(19) United States
(12) Patent Application Publication
(10) Pub. No.: US 2022/0075592 A1
(43) Pub. Date: Mar. 10, 2022

(54) VOICE PROCESSING SYSTEM, VOICE PROCESSING METHOD AND RECORDING MEDIUM RECORDING VOICE PROCESSING PROGRAM

(71) Applicant: SHARP KABUSHIKI KAISHA, Sakai City (JP)

(72) Inventors: DAISUKE YAMASHITA, Sakai City (JP); KAZUO MAKIJIMA, Sakai City (JP)

(21) Appl. No.: 17/462,502

(22) Filed: Aug. 31, 2021

(30) Foreign Application Priority Data
Sep. 8, 2020 (JP) 2020-150854

(51) Int. Cl. G06F 3/16; G10L 15/22; G10L 15/08

(52) U.S. Cl. CPC G06F 3/167; G10L 2015/223; G10L 15/08; G10L 15/22

(57) ABSTRACT

A voice processing system includes: a display processing processor that displays an operation screen for an operation target application serving as a target to be operated by the user; a support information presenter that presents operation support information for the operation target application such that the operation support information is associated with the operation screen; a voice receiver that receives the voice of the user; a command identifier that identifies, based on the voice received by the voice receiver, a first command for the operation target application; and a command executor that executes, on the operation target application, the first command identified by the command identifier.

### INCORPORATION BY REFERENCE

This application is based upon and claims the benefit of priority from the corresponding Japanese Patent Application No. 2020-150854 filed on Sep. 8, 2020, the entire contents of which are incorporated herein by reference.

### BACKGROUND

The present disclosure relates to voice processing systems, voice processing methods and recording media that record voice processing programs.

In recent years, voice processing systems have been known that recognize a voice of a user to be able to execute a predetermined command corresponding to the voice. For example, in a case where a material is displayed by a predetermined application on a display device, when a user produces a voice for providing an instruction to turn (flip) pages of the material, a voice processing system executes, according to the voice, a command for turning the pages of the material.

Conventionally, for the voice processing system described above, a technique is proposed in which when voice recognition is not successful, voice commands that can be achieved by voice recognition are displayed in a list.

However, in the conventional technique, it is difficult for the user to grasp voice commands that can be achieved by voice recognition in a stage preceding the voice recognition. It is also difficult for the user to grasp parts that can be operated by the voice commands on an operation screen displayed in the display device. As described above, in the conventional voice processing system, the inconvenience of operations using voice commands is disadvantageously caused.

### SUMMARY

An object of the present disclosure is to provide a voice processing system, a voice processing method and a recording medium for recording a voice processing program that can enhance the convenience of operations using voice commands.

A voice processing system according to an aspect of the present disclosure is a voice processing system that executes a predetermined command based on a voice of a user, and includes: a display processing processor that displays an operation screen for an operation target application serving as a target to be operated by the user; a support information presenter that presents operation support information for the operation target application such that the operation support information is associated with the operation screen; a voice receiver that receives the voice of the user; a command identifier that identifies, based on the voice received by the voice receiver, a first command for the operation target application; and a command executor that executes, on the operation target application, the first command identified by the command identifier.

A voice processing method according to another aspect of the present disclosure is a voice processing method that executes a predetermined command based on a voice of a user and that is executed by one or a plurality of processors, and includes: displaying an operation screen for an operation target application serving as a target to be operated by the user; presenting operation support information for the operation target application such that the operation support information is associated with the operation screen; receiving the voice of the user; identifying, based on the voice received in the receiving of the voice, a first command for the operation target application; and executing, on the operation target application, the first command identified in the identifying of the first command.

A recording medium according to another aspect of the present disclosure records a voice processing program that executes a predetermined command based on a voice of a user, the program being for instructing one or a plurality of processors to execute: displaying an operation screen for an operation target application serving as a target to be operated by the user; presenting operation support information for the operation target application such that the operation support information is associated with the operation screen; receiving the voice of the user; identifying, based on the voice received in the receiving of the voice, a first command for the operation target application; and executing, on the operation target application, the first command identified in the identifying of the first command.

According to the present disclosure, a voice processing system, a voice processing method and a recording medium for recording a voice processing program that can enhance the convenience of operations using voice commands are provided.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a functional block diagram showing the configuration of a voice processing system according to an embodiment of the present disclosure.

FIG. 2 is a diagram showing an example of command information used in the voice processing system according to the embodiment of the present disclosure.

FIG. 3 is a diagram showing an example of display screens displayed on a display device in the voice processing system according to the embodiment of the present disclosure.

FIG. 4 is a diagram showing an example of the display screens displayed on the display device in the voice processing system according to the embodiment of the present disclosure.

FIG. 5 is a diagram showing an example of the display screens displayed on the display device in the voice processing system according to the embodiment of the present disclosure.

FIG. 6 is a flowchart for illustrating an example of a procedure of voice processing in the voice processing system according to the embodiment of the present disclosure.

FIG. 7 is a diagram showing an example of the display screens displayed on the display device in the voice processing system according to the embodiment of the present disclosure.

FIG. 8 is a diagram showing an example of the display screens displayed on the display device in the voice processing system according to the embodiment of the present disclosure.

FIG. 9 is a diagram showing an example of the display screens displayed on the display device in the voice processing system according to the embodiment of the present disclosure.

FIG. 10 is a diagram showing an example of the display screens displayed on the display device in the voice processing system according to the embodiment of the present disclosure.

FIG. 11 is a diagram showing an example of the display screens displayed on the display device in the voice processing system according to the embodiment of the present disclosure.

FIG. 12 is a diagram showing an example of the display screens displayed on the display device in the voice processing system according to the embodiment of the present disclosure.

### DETAILED DESCRIPTION

Embodiments of the present disclosure will be described below with reference to accompanying drawings. The following embodiments are examples obtained by embodying the present disclosure, and are not intended to limit the technical scope of the present disclosure.

Voice Processing System 100

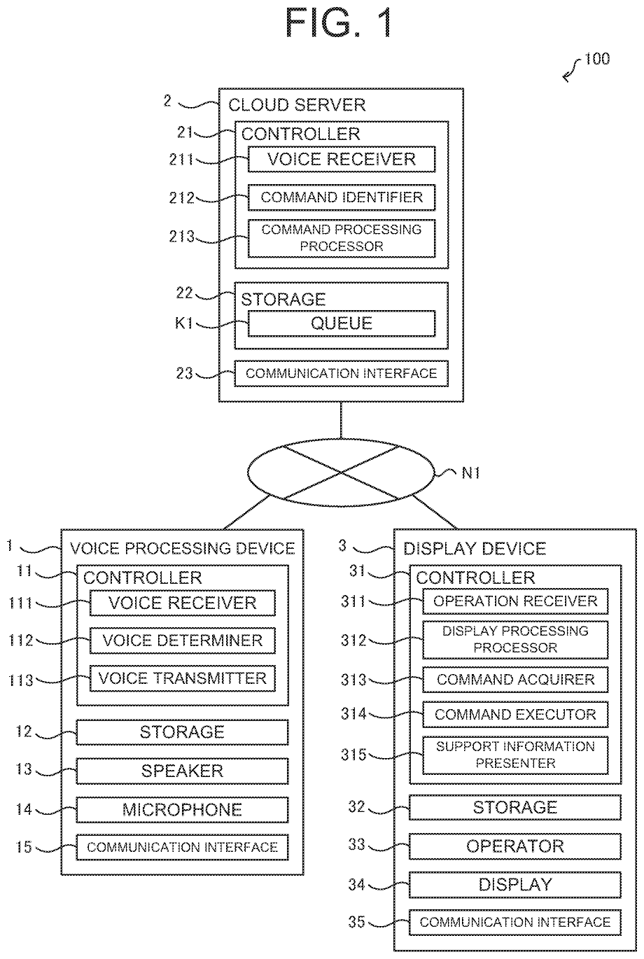

FIG. 1 is a diagram showing a schematic configuration of a voice processing system according to an embodiment of the present disclosure. The voice processing system 100 includes a voice processing device 1, a cloud server 2 and a display device 3. The voice processing device 1 is a microphone-speaker device that includes a speaker 13 and a microphone 14, and is, for example, an AI speaker, a smart speaker or the like. The voice processing device 1, the cloud server 2 and the display device 3 are connected to each other through a network N1. The network N1 is a communication network such as the Internet, a LAN, a WAN or a public telephone line. The cloud server 2 is formed, for example, with one or a plurality of data servers (virtual servers). The cloud server 2 may be replaced by one physical server. The voice processing system 100 can execute a predetermined command based on a voice of a user.

Voice Processing Device 1

As shown in FIG. 1, the voice processing device 1 includes a controller 11, a storage 12, the speaker 13, the microphone 14, a communication interface 15 and the like. The voice processing device 1 is placed, for example, on a desk, and acquires the voice of the user through the microphone 14 and outputs a voice to the user from the speaker 13.

The communication interface 15 is a communication interface for connecting the voice processing device 1 to the network N1 by wired or wireless connection and executing, through the network N1, data communication corresponding to a predetermined communication protocol with other devices (for example, the cloud server 2 and the display device 3). The communication interface 15 may be a communication interface that can realize a videoconference system (which will be described later).

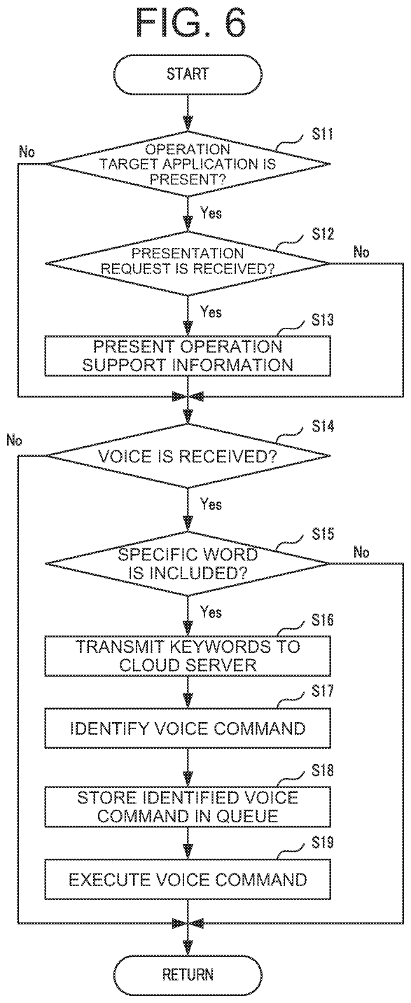

The storage 12 is a nonvolatile storage, such as a flash memory, that stores various types of information. In the storage 12, control programs such as a voice processing program for instructing the controller 11 to execute voice processing (see FIG. 6) which will be described later are stored. For example, the voice processing program is disturbed from the cloud server 2 to be stored. The voice processing program may be recorded, in a non-transitory manner, in a computer-readable recording medium such as a CD or a DVD, read by a reading device (not shown), such as a CD drive or a DVD drive, included in the voice processing device 1 and stored in the storage 12.

The controller 11 includes control devices such as a CPU, a ROM and a RAM. The CPU is a processor that executes various types of computation processing. The ROM previously stores control programs, such as a BIOS and an OS, that instruct the CPU to execute various types of processing. The RAM stores various types of information, and is used as a temporary storage memory (operational region) for the various types of processing executed by the CPU. The controller 11 makes the CPU execute various types of control programs previously stored in the ROM or the storage 12 so as to control the voice processing device 1.

Specifically, the controller 11 includes various types of processing processors such as a voice receiver 111, a voice determiner 112 and a voice transmitter 113. The controller 11 functions as the various types of processing processors by making the CPU execute the various types of processing corresponding to the control programs. Part or all of the processing processors included in the controller 11 may be formed with an electronic circuit. The voice processing program may be a program for making a plurality of processors function as the various types of processing processors.

The voice receiver 111 receives a voice produced by the user who utilizes the voice processing device 1. The voice receiver 111 is an example of a voice receiver in the present disclosure. The user produces, for example, the voice of a specific word (also referred to as a start-up word or a wakeup word) for making the voice processing device 1 start the reception of a voice command, the voices (command voices) of various types of voice commands for providing instructions to the voice processing device 1 and the like. The voice receiver 111 receives various types of voices produced by the user.

The voice determiner 112 determines, based on the voice received by the voice receiver 111, whether or not the voice includes the specific word. For example, the voice determiner 112 recognizes the voice received by the voice receiver 111, and converts it into text data. Then, the voice determiner 112 determines whether or not the beginning of the text data includes the specific word.

The voice transmitter 113 executes, based on the result of the determination by the voice determiner 112, transmission processing for the voice received by the voice receiver 111. Specifically, when the voice determiner 112 determines that the voice received by the voice receiver 111 includes the specific word, the voice transmitter 113 transmits, to the cloud server 2, the text data of keywords (command keywords) that are included in the voice and that are subsequent to the specific word. On the other hand, when the voice determiner 112 determines that the voice received by the voice receiver 111 does not include the specific word, the voice transmitter 113 does not transmit the voice to the cloud server 2. In this way, when the voice of the specific word is produced, the command keywords are transmitted to the cloud server 2, and thus it is possible to prevent the voice of normal conversation that does not include the specific word from being erroneously transmitted to the cloud server 2.

Cloud Server 2

As shown in FIG. 1, the cloud server 2 includes a controller 21, a storage 22, a communication interface 23 and the like.

The communication interface 23 is a communication interface for connecting the cloud server 2 to the network N1 by wired or wireless connection and executing, through the network N1, data communication corresponding to a predetermined communication protocol with other devices (for example, the voice processing device 1 and the display device 3).

The storage 22 is a nonvolatile storage, such as a flash memory, that stores various types of information. In the storage 22, control programs such as the voice processing program for instructing the controller 21 to execute the voice processing (see FIG. 6) which will be described later are stored. For example, the voice processing program may be recorded, in a non-transitory manner, in a computer-readable recording medium such as a CD or a DVD, read by a reading device (not shown), such as a CD drive or a DVD drive, included in the cloud server 2 and stored in the storage 22. In the storage 22, the text data of the command keywords received from the voice processing device 1 and the like are stored.

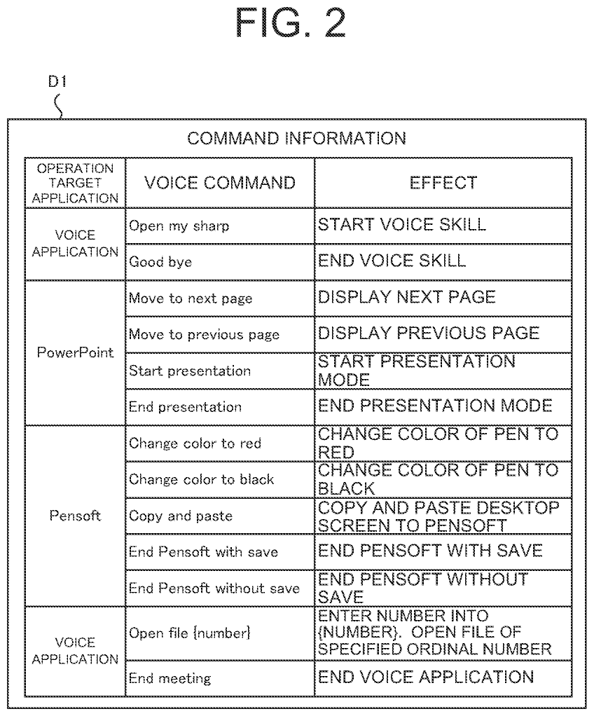

In the storage 22, command information D1 is stored. FIG. 2 shows an example of the command information D1. In the command information D1, pieces of information such as operation target applications, voice commands and effects are registered so as to be associated with each other. The operation target application is an application that is executed by the user on the display device 3. The operation target application may be operated in the cloud server 2 to receive the operation on the display device 3 or may be installed in the display device 3 to be operated. In the present embodiment, as the operation target applications, a “voice application” which starts and ends voice processing for executing the voice command corresponding to the voice of the user, “Power Point” (registered trademark), which can display and edit various types of materials in slide format and “Pensoft”, which can execute writing on a touch panel with a touch pen or the like are registered.

The voice command is a command that can be executed in the voice processing system 100, and is registered for each of the operation target applications. The voice command corresponds to the command keywords described above. The effect is information that indicates the details of an operation executed by the voice command. For example, in a case where the first page of a material is displayed on the display device 3 by the “Power Point”, when the user produces the voice of a voice command (command keywords) of “Move to next page”, the voice processing system 100 executes the voice command to display the second page of the material on the display device 3.

In another embodiment, part or all of the command information D1 may be stored in either of the voice processing device 1 and the display device 3 or may be stored so as to be distributed to these devices. In another embodiment, the information may also be stored in a server that can be accessed from the voice processing system 100. In this case, the voice processing system 100 may acquire the information from the server to execute various types of processing such as the voice processing (see FIG. 6) which will be described later.

The controller 21 includes control devices such as a CPU, a ROM and a RAM. The CPU is a processor that executes various types of computation processing. The ROM previously stores control programs, such as a BIOS and an OS, that instruct the CPU to execute various types of processing. The RAM stores various types of information, and is used as a temporary storage memory (operational region) for the various types of processing executed by the CPU. The controller 21 makes the CPU execute various types of control programs previously stored in the ROM or the storage 22 so as to control the cloud server 2.

As shown in FIG. 1, the controller 21 includes various types of processing processors such as a voice receiver 211, a command identifier 212 and a command processing processor 213. The controller 21 functions as the various types of processing processors by making the CPU execute the various types of processing corresponding to the control programs. Part or all of the processing processors included in the controller 21 may be formed with an electronic circuit. The control programs may be programs for making a plurality of processors function as the various types of processing processors.

The voice receiver 211 receives the command keywords corresponding to the voice command transmitted from the voice processing device 1. The command keywords are words (text data) that are included in the beginning of the text data of the voice received by the voice processing device 1 and that are subsequent to the specific word. Specifically, when the voice processing device 1 detects the specific word and transmits the command keywords to the cloud server 2, the cloud server 2 receives the command keywords.

The command identifier 212 identifies the voice command based on the command keywords received by the voice receiver 211. The command identifier 212 is an example of the command identifier 212 in the present disclosure. For example, the command identifier 212 references the command information D1 (see FIG. 2) to identify the voice command corresponding to the command keywords. When the user produces, for the operation target application, the voice of the command keywords corresponding to a predetermined voice command, the command identifier 212 identifies, based on the command keywords, the voice command (that corresponds to a first command in the present disclosure) for the operation target application. The command identifier 212 is an example of a command identifier in the present disclosure.

Although in the present embodiment, a plurality of voice commands described above are previously registered in the command information D1, and the voice command corresponding to the command keywords is identified from the command information D1, a method for identifying the voice command is not limited to this method. For example, the command identifier 212 may interpret the meaning of details of the instruction of the user based on a predetermined term included in the command keywords, the clause and the syntax of the entire command keywords and the like so as to identify the voice command. For example, the command identifier 212 may use a known method such as a morphological analysis, parsing, a semantic analysis or machine learning so as to identify the voice command from the command keywords.

The command processing processor 213 stores, in a command storage region (queue) corresponding to the display device 3, the information of the voice command identified by the command identifier 212. For example, the storage 22 includes one or a plurality of command storage regions corresponding to the display device 3. Here, the storage 22 includes a queue K1 corresponding to the display device 3. When a plurality of display devices 3 are included in the voice processing system 100, a queue for each of the display devices 3 may be stored in the storage 22.

For example, the command processing processor 213 stores, in the queue K1 corresponding to the display device 3, the information of the voice command of the “Move to next page” identified by the command identifier 212.

The data (voice command) stored in the queue K1 is taken out by the display device 3 corresponding to the queue K1, and the display device 3 executes the voice command.

Display Device 3

As shown in FIG. 2, the display device 3 includes a controller 31, a storage 32, an operator 33, a display 34, a communication interface 35 and the like.

The operator 33 is a mouse, a keyboard, a touch panel or the like that receives the operation executed by the user on the display device 3. The display 34 is a display panel, such as a liquid crystal display or an organic EL display, that displays various types of information. The operator 33 and the display 34 may be a user interface that is formed integrally.

The communication interface 35 is a communication interface for connecting the display device 3 to the network N1 by wired or wireless connection and executing, through the network N1, data communication corresponding to a predetermined communication protocol with other devices (for example, the voice processing device 1 and the cloud server 2).

The storage 32 is a nonvolatile storage, such as a flash memory, that stores various types of information. In the storage 32, control programs such as the voice processing program for instructing the controller 31 to execute the voice processing (see FIG. 6) which will be described later are stored. For example, the voice processing program may be recorded, in a non-transitory manner, in a computer-readable recording medium such as a CD or a DVD, read by a reading device (not shown), such as a CD drive or a DVD drive, included in the display device 3 and stored in the storage 32.

The controller 31 includes control devices such as a CPU, a ROM and a RAM. The CPU is a processor that executes various types of computation processing. The ROM previously stores control programs, such as a BIOS and an OS, that instruct the CPU to execute various types of processing. The RAM stores various types of information, and is used as a temporary storage memory (operational region) for the various types of processing executed by the CPU. The controller 31 makes the CPU execute various types of control programs previously stored in the ROM or the storage 32 so as to control the display device 3.

Specifically, the controller 31 includes various types of processing processors such as an operation receiver 311, a display processing processor 312, a command acquirer 313, a command executor 314 and a support information presenter 315. The controller 31 functions as the various types of processing processors by making the CPU execute the various types of processing corresponding to the control programs. Part or all of the processing processors included in the controller 31 may be formed with an electronic circuit. The control programs may be programs for making a plurality of processors function as the various types of processing processors.

The operation receiver 311 receives various types of operations of the user. Specifically, the operation receiver 311 receives the operation executed by the user on the operator 33. For example, the operation receiver 311 receives an operation for starting up a predetermined application (such as the operation target application), an operation on an operation screen operated by the operation target application, an operation for opening a predetermined file and the like. The operation receiver 311 also receives, from the user, an operation for requesting the presentation of operation support information described later.

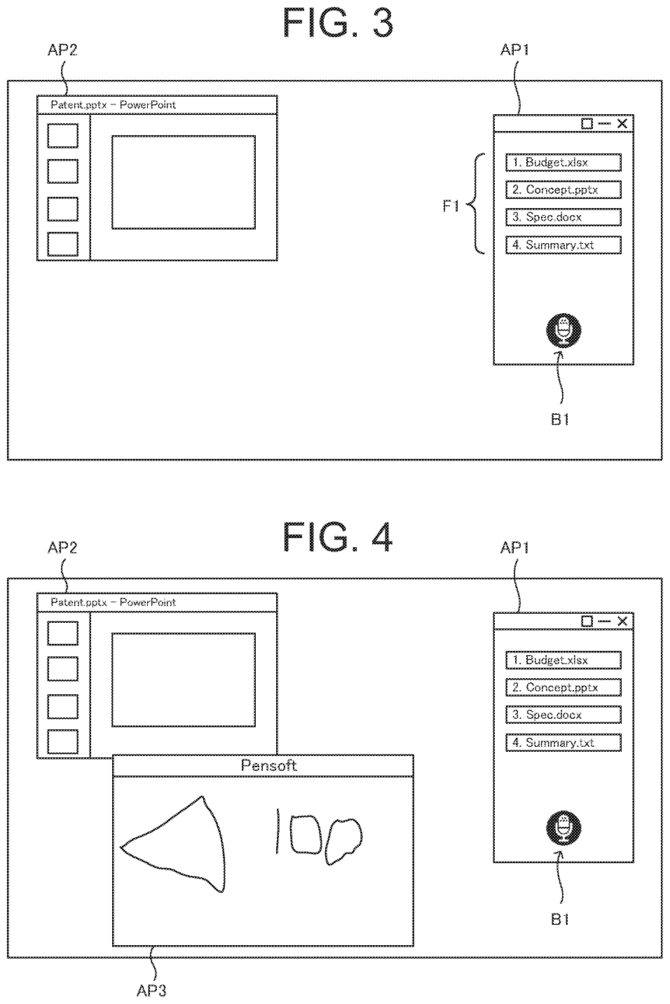

The display processing processor 312 displays various types of information on the display 34. For example, the display processing processor 312 displays, on the display 34, an operation screen for the operation target application serving as a target to be operated by the user. FIGS. 3 and 4 show examples of the operation screen displayed on the display 34. In the example shown in FIG. 3, an operation screen for an operation target application AP1 of the “voice application” and an operation screen for an operation target application AP2 of the “Power Point” are displayed. In the example shown in FIG. 4, the operation screen for the operation target application AP1, the operation screen for the operation target application AP2 and an operation screen for an operation target application AP3 of the “Pensoft” are displayed.

On the operation screen for the operation target application AP1, a plurality of files F1 that can be displayed are displayed in a list. The user can specify a desired file from the list by use of a voice or the like. On the operation screen for the operation target application AP1, an operation button B1 for requesting the presentation of the operation support information is displayed. When the user requests the presentation of the operation support information, the user selects (presses down) the operation button B1 with a finger, a touch pen, a mouse or the like.

The command acquirer 313 acquires the voice command stored in the command storage region (queue K1) of the cloud server 2. Specifically, the command acquirer 313 monitors the queue K1 corresponding to the display device 3, and acquires the voice command when the voice command is stored in the queue K1. For example, when the operation button B1 is pressed down, the command acquirer 313 periodically (for example, at intervals of 5 seconds) makes an inquiry to the queue K1 so as to acquire the voice command. The command processing processor 213 of the cloud server 2 may transmit data on the voice command to the display device 3, and the command acquirer 313 may acquire the voice command.

The command executor 314 executes, on the operation target application, the voice command identified by the command identifier 212 of the cloud server 2. The command executor 314 is an example of a command executor in the present disclosure. Specifically, the command executor 314 executes the voice command acquired by the command acquirer 313. For example, the command executor 314 executes the voice command acquired by the command acquirer 313 from the queue K1.

For example, in a case where the first page of a material is displayed on the display 34 of the display device 3 by the “Power Point”, when the user produces the voice of the voice command (command keywords) of the “Move to next page”, the command executor 314 executes the voice command acquired by the command acquirer 313 from the queue K1. In this way, the second page of the material is displayed on the display 34 of the display device 3.

Here, for the operation screens shown in FIGS. 3 and 4, it is difficult for the user to grasp, at a glance, for example, which one of the operation screens for the operation target applications can be operated by the voice command or what voice command allows the operation of the operation screen described above.

Hence, the support information presenter 315 presents information (operation support information) for supporting the operation executed by the user to the user who operates the operation screen described above. Specifically, the support information presenter 315 presents the operation support information for the operation target application such that the operation support information is associated with the operation screen. When the operation receiver 311 receives, from the user, the operation for requesting the presentation of the operation support information, the support information presenter 315 may present the operation support information. For example, when the user presses down the operation button B1 on the operation screen shown in FIG. 4, the support information presenter 315 may present the operation support information. For example, when the user produces a voice for starting the voice processing and then the voice receiver 211 of the cloud server 2 receives the voice, the support information presenter 315 may present the operation support information. The support information presenter 315 is an example of a support information presenter in the present disclosure.

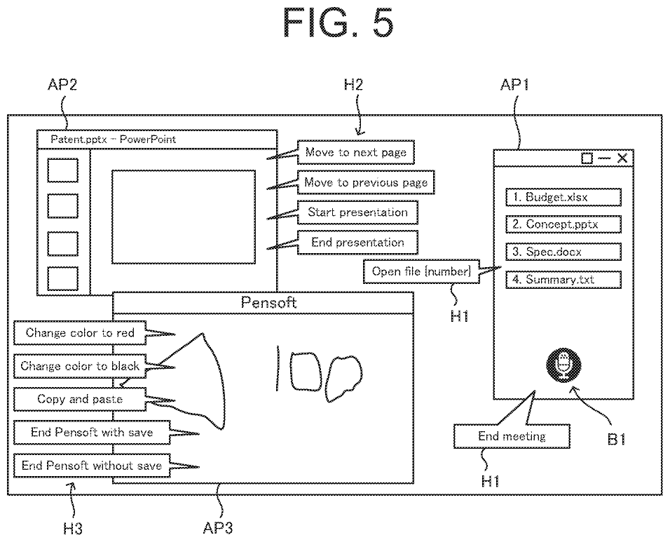

FIG. 5 shows an example of the operation screen that includes the operation support information. FIG. 5 shows the operation support information corresponding to the operation screen of FIG. 4. The support information presenter 315 presents the operation support information corresponding to one or a plurality of commands for the operation target application such that the operation support information is associated with the operation screen. For example, as shown in FIG. 5, the support information presenter 315 presents operation support information H1 corresponding to the voice command for the operation target application AP1 of the “voice application” such that the operation support information H1 is associated with the operation screen for the operation target application AP1. The support information presenter 315 also presents operation support information H2 corresponding to the voice command for the operation target application AP2 of the “Power Point” such that the operation support information H2 is associated with the operation screen for the operation target application AP2. The support information presenter 315 also presents operation support information H3 corresponding to the voice command for the operation target application AP3 of the “Pensoft” such that the operation support information H3 is associated with the operation screen for the operation target application AP3. Each of the operation support information H1, the operation support information H2 and the operation support information H3 is formed with speech balloon object images and the text information of the voice commands. The support information presenter 315 displays the operation support information H1 such that at least part thereof overlaps the operation screen for the operation target application AP1, displays the operation support information H2 such that at least part thereof overlaps the operation screen for the operation target application AP2 and displays the operation support information 113 such that at least part thereof overlaps the operation screen for the operation target application AP3. When a plurality of pieces of the operation support information for the operation screen are present, the support information presenter 315 displays the pieces of the operation support information such that they are aligned.

When the user presses down the operation button B1 again, the support information presenter 315 may delete (hide) all the operation support information.

In this configuration, for example, the user can grasp, at a glance, that the operation screens for the operation target applications AP1, AP2 and AP3 can be operated and also can grasp, at a glance, the types (details) of voice commands which can be executed on the operation screens.

Voice Processing

An example of the procedure of the voice processing executed by the controller 11 of the voice processing device 1, the controller 21 of the cloud server 2 and the controller 31 of the display device 3 will be described below with reference to FIG. 6.

The present disclosure can be regarded as the disclosure of a voice processing method for executing one or a plurality of steps included in the voice processing. The one or plurality of steps included in the voice processing described here may be omitted as necessary. The order in which the steps of the voice processing are executed may be different as long as the same functional effects are produced. Furthermore, although here, a case where the steps of the voice processing are executed by the controllers 11, 21 and 31 is described as an example, in another embodiment, the steps of the voice processing may be executed by one or a plurality of processors so as to be distributed.

Here, for example, it is assumed that the operation screens shown in FIG. 4 are displayed on the display 34 of the display device 3 and that the user can operate the operation screens for the operation target applications by use of a voice.

In step S11, the controller 31 determines whether or not the operation target application that can be operated by the user is present on the display device 3. When the operation target application is present (S11: yes), the processing is transferred to step S12. On the other hand, when the operation target application is not present (S11: no), the processing is transferred to step S14. For example, when as shown in FIG. 4, the operation screen for at least one of the operation target applications is displayed on the display device 3, the controller 31 determines that the operation target application is present.

In step S12, the controller 31 of the display device 3 determines whether or not an operation for requesting the presentation of the operation support information is received from the user. When the operation for requesting the presentation of the operation support information is received from the user (S12: yes), the processing is transferred to step S13. On the other hand, when the operation for requesting the presentation of the operation support information is not received from the user (S12: no), the processing is transferred to step S14. For example, when the user presses down the operation button B1 on the operation screen shown in FIG. 4, the controller 31 determines that the operation for requesting the presentation of the operation support information is received from the user. The operation button B1 may be displayed within any one of the operation screens for the operation target applications or may be displayed outside the operation screens for the operation target applications.

In step S13, the controller 31 presents the information (operation support information) for supporting the operation of the user to the user who operates the operation screen. Specifically, the controller 31 presents the operation support information for the operation target application such that the operation support information is associated with the operation screen.

For example, as shown in FIG. 5, the controller 31 presents the operation support information H1 corresponding to the voice command for the operation target application AP1 of the “voice application” such that the operation support information H1 is associated with the operation screen for the operation target application AP1, also presents the operation support information H2 corresponding to the voice command for the operation target application AP2 of the “Power Point” such that the operation support information H2 is associated with the operation screen for the operation target application AP2 and also presents the operation support information H3 corresponding to the voice command for the operation target application AP3 of the “Pensoft” such that the operation support information H3 is associated with the operation screen for the operation target application AP3. Step S13 is an example of presenting operation support information in the present disclosure.

In step S14, the controller 11 of the voice processing device 1 determines whether or not the voice of the user is received. When the controller 11 receives the voice of the user (S14: yes), the processing is transferred to step S15. On the other hand, when the controller 11 does not receive the voice of the user (S14: no), the processing is returned to step S11. Step S14 is an example of receiving the voice in the present disclosure.

In step S15, the controller 11 determines, based on the received voice, whether or not the voice includes the specific word. For example, the controller 11 recognizes the received voice and converts it into text data so as to determine whether or not the beginning of the text data includes the specific word. When the voice includes the specific word (S15: yes), the processing is transferred to step S16. When the voice does not include the specific word (S15: no), the processing is returned to step S11.

In step S16, the controller 11 transmits, to the cloud server 2, the text data of keywords (command keywords) that are included in the voice and that are subsequent to the specific word.

Then, in step S17, the controller 21 of the cloud server 2 receives the command keywords transmitted from the voice processing device 1, and identifies the voice command based on the command keywords. For example, the controller 21 references the command information D1 shown in FIG. 2 to identify the voice command corresponding to the command keywords. Step S17 is an example of identifying a command in the present disclosure.

Then, in step S18, the controller 11 stores the information of the identified voice command in the queue K1 corresponding to the display device 3.

Then, in step S19, the controller 31 of the display device 3 executes the voice command identified for the operation target application. Specifically, the controller 31 acquires the voice command from the queue K1 corresponding to the display device 3 to execute the voice command. Step S19 is an example of executing the command in the present disclosure. In this way, the voice processing system 100 executes the voice processing.

As described above, the voice processing system 100 according to the present embodiment displays the operation screen for the operation target application serving as the target to be operated by the user, and presents the operation support information for the operation target application such that the operation support information is associated with the operation screen. The voice processing system 100 receives the voice of the user, identifies a first command for the operation target application based on the voice and executes the first command for the operation target application. In this way, the user can grasp, at a glance, for example, which one of the operation screens can be operated by the voice command or what voice command allows the operation of the operation screen. Hence, it is possible to enhance the convenience of operations using voice commands.

The present disclosure is not limited to the embodiment described above. Other embodiments of the present disclosure will be described below.

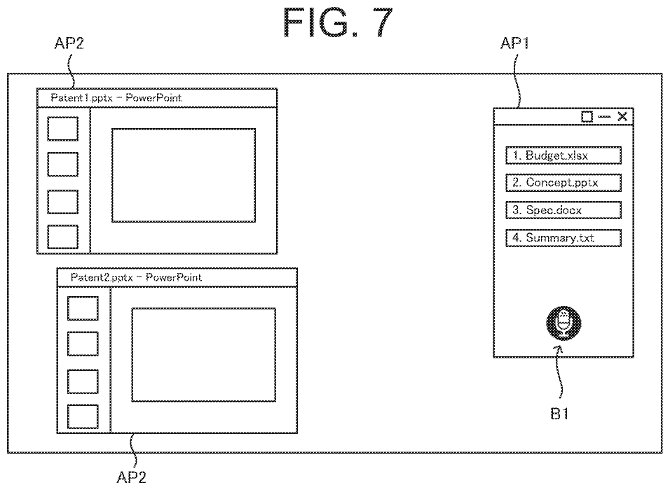

Here, when a plurality of operation screens for the same operation target application are displayed on the display device 3, it is difficult for the user to grasp, at a glance, for example, which one of the operation screens can be operated by the voice command or what voice command allows the operation of the operation screen. For example, when as shown in FIG. 7, two operation screens for the operation target application AP2 of the “Power Point” are displayed on the display device 3, it is difficult for the user to grasp, at a glance, for example, which one of the operation screens can be operated by the voice command or what voice command allows the operation of the operation screen.

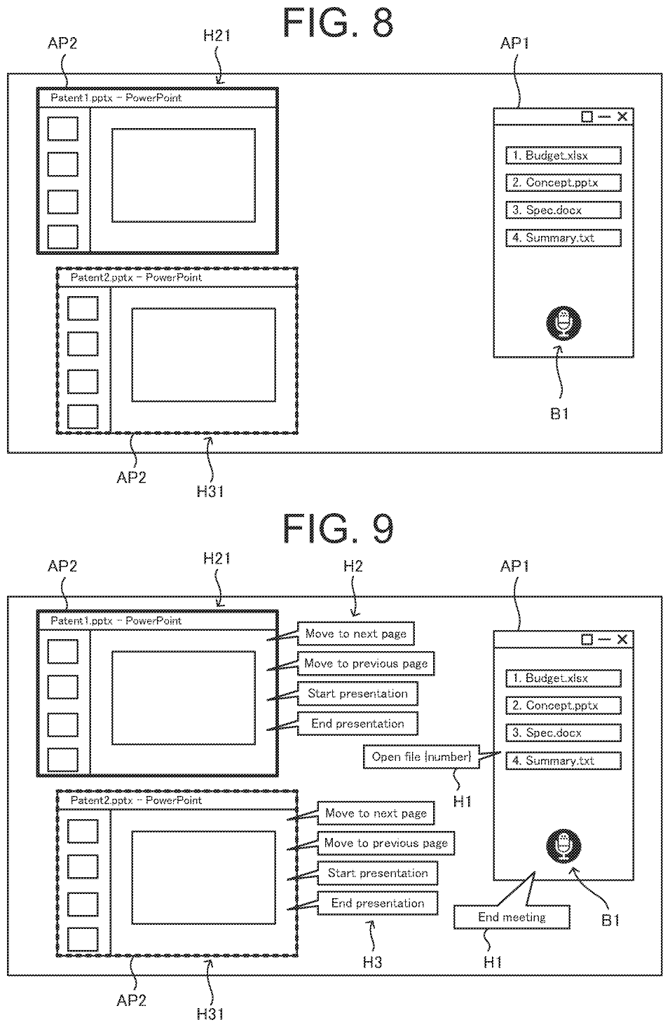

Hence, in a voice processing system 100 according to another embodiment, when a plurality of operation screens for the same operation target application are displayed on the display device 3, the controller 31 (support information presenter 315) of the display device 3 presents screen identification information capable of identifying the operation screens such that the screen identification information is associated with each of the operation screens. The screen identification information is an example of operation support information in the present disclosure. For example, as shown in FIG. 8, the controller 31 displays screen identification information H21 of a red frame (indicated by “thick lines” in FIG. 8 for convenience) on one of the operation screens and screen identification information H31 of a blue frame (indicated by “dotted lines” in FIG. 8 for convenience) on the other operation screen. In this way, for example, the user can identify, with the screen identification information, the operation screen, of the two operation screens, for executing the voice command or can specify the operation screen with the screen identification information. For example, when the user produces the voice of the voice command (command keywords) of “Move to next page by red”, the operation screen on the upper side in the figure is specified, and the voice command for the operation screen is identified, with the result that the page of the material displayed on the operation screen is turned to the next page.

For example, when the user presses down the operation button B1, the controller 31 displays the screen identification information 1121 and the screen identification information 1131.

For example, when the user presses down the operation button B1, the controller 31 may display, as shown in FIG. 9, in addition to the screen identification information 1121 and the screen identification information 1131, the operation support information 111, the operation support information 112 and the operation support information 113 formed with speech balloon object images and the text information of the voice commands.

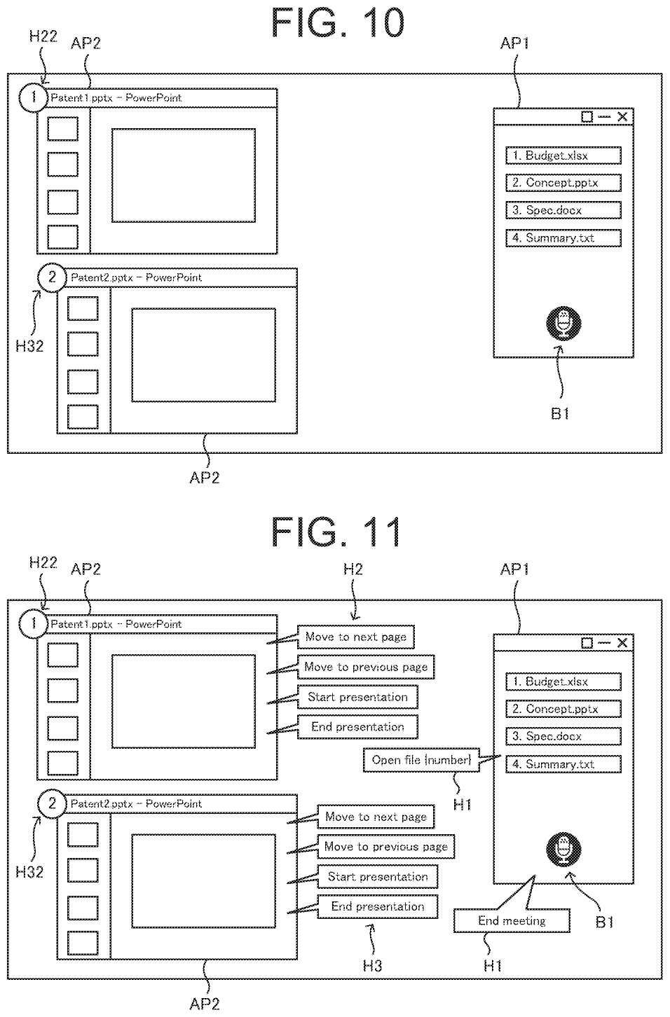

The screen identification information is not limited to identification information corresponding to colors, and may be identification information corresponding to numbers as shown in FIGS. 10 and 11. In this case, when the user produces the voice of the voice command (command keywords) of “Move to next page by two”, the operation screen on the lower side in the figure is specified, and the voice command for the operation screen is identified. The screen identification information may be identification information corresponding to the positions (such as the upper side, the lower side, the left side and the right side) of the operation screens, the types of lines of outer frames or the widths of the lines thereof.

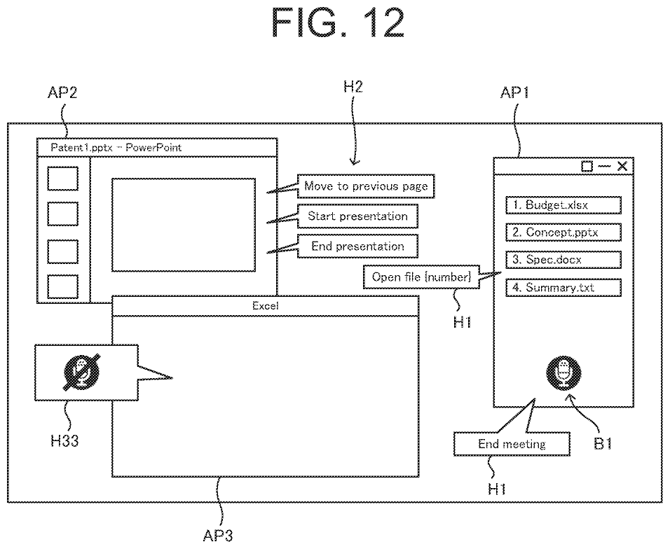

In another embodiment, the controller 31 (support information presenter 315) of the display device 3 may identifiably present text information (operation support information) corresponding to a voice command executable at present by the command executor 314 among one or a plurality of voice commands such that the text information is associated with the operation screen. For example, in an example shown in FIG. 12, when the final page of the material is displayed on the operation screen for the operation target application AP2 of the “Power Point”, since the next page is not present, the command executor 314 cannot execute the voice command of the “Move to next page”. The support information presenter 315 deletes (hides) the operation support information 112 corresponding to the voice command of the “Move to next page” so as to present only the operation support information H2 corresponding to the voice commands executable at present.

When in FIG. 12, the voice command executable on the operation screen for the operation target application AP3 of “Excel” is not present, the support information presenter 315 may present operation support information H33 indicating that the voice command corresponding to the operation screen for the operation target application AP3 is not received.

In another embodiment, the controller 31 (support information presenter 315) of the display device 3 may identifiably present, among one or a plurality of voice commands, only operation support information corresponding to a voice command having the frequency of use equal to or greater than a predetermined frequency such that the operation support information is associated with the operation screen. The support information presenter 315 may identifiably present, among one or a plurality of voice commands, only operation support information corresponding to a predetermined number of (for example, five) voice commands higher than any other voice commands in the frequency of use such that the operation support information is associated with the operation screens.

In another embodiment, the controller 31 (support information presenter 315) of the display device 3 may identifiably present, in a plurality of pieces of operation support information shown in FIG. 5, pieces of operation support information corresponding to a voice command capable of being subsequently operated by the user, a voice command incapable of being subsequently operated by the user, a voice command which may be operated by the user and the like such that they are associated with the operation screens. For example, on the operation screen for the operation target application AP2 of the “Power Point”, the support information presenter 315 displays the operation support information H2 corresponding to the voice command of the “Move to next page” capable of being subsequently operated such that the operation support information H2 blinks, and displays the operation support information H2 corresponding to the voice command of “Move to previous page” incapable of being subsequently operated such that the operation support information H2 is grayed out. As described above, candidates for the subsequent operation may be proposed.

In another embodiment, the controller 31 (support information presenter 315) of the display device 3 may display the operation support information such that the operation support information is associated with an operation target position. For example, the support information presenter 315 displays, when an operation button (object image) for flipping pages is displayed on the operation screen for the operation target application AP2, part (balloon) of the balloon object image of the operation support information such that the part overlaps the operation button. In this way, the user can easily grasp command keywords (command voice) corresponding to details desired to be operated.

The voice processing system of the present disclosure is applicable to videoconference systems. For example, the voice processing system 100 includes a first voice processing device 1 and a first display device 3 placed in a first conference room and a second voice processing device 1 and a second display device 3 placed in a second conference room. The first voice processing device 1 and the first display device 3, the second voice processing device 1 and the second display device 3 and the cloud server 2 are connected to each other through the network N1, and thus a videoconference between the first conference room and the second conference room is realized. In the videoconference, for example, the display processing processor 312 of the first display device 3 displays two operation screens for the operation target application AP2 of the “Power Point” (see FIG. 8 and the like). The display processing processor 312 of the second display device 3 displays the same operation screens as the first display device 3, that is, the two operation screens for the operation target application AP2 of the “Power Point”. In this case, the support information presenter 315 of the first display device 3 displays, on the first display device 3, the screen identification information 1121 and the screen identification information 1131 capable of identifying the two operation screens such that they are associated with the respective operation screens. Likewise, the support information presenter 315 of the second display device 3 displays, on the second display device 3, the screen identification information 1121 and the screen identification information 1131 capable of identifying the two operation screens such that they are associated with the respective operation screens. As described above, each of a plurality of display devices 3 in a videoconference system executes the above-described processing executed by the controller 31. In this way, it is possible to enhance the convenience of operations using voice commands executed by users who participate in the videoconference.

In the voice processing system of the present disclosure, without departing from the scope of the disclosure recited in claims, the embodiments described above can be freely combined or can be varied or partially omitted as necessary.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. A voice processing system that executes a predetermined command based on a voice of a user, the voice processing system comprising:
a display processing processor that displays an operation screen for an operation target application serving as a target to be operated by the user;
a support information presenter that presents operation support information for the operation target application such that the operation support information is associated with the operation screen;
a voice receiver that receives the voice of the user;
a command identifier that identifies, based on the voice received by the voice receiver, a first command for the operation target application; and
a command executor that executes, on the operation target application, the first command identified by the command identifier.

2. The voice processing system according to claim 1,
wherein the support information presenter presents the operation support information corresponding to one or a plurality of commands for the operation target application such that the operation support information is associated with the operation screen,
the command identifier identifies the first command among the one or plurality of commands based on the voice received by the voice receiver and
the command executor executes the first command identified by the command identifier.

3. The voice processing system according to claim 2,
wherein the support information presenter presents text information of one or a plurality of specific words which respectively correspond to the one or plurality of commands such that the text information is associated with the operation screen.

4. The voice processing system according to claim 3,
wherein the support information presenter identifiably presents the text information corresponding to a command executable at present by the command executor among the one or plurality of commands such that the text information is associated with the operation screen.

5. The voice processing system according to claim 4,
wherein the support information presenter presents only the text information corresponding to the command executable at present by the command executor among the one or plurality of commands such that the text information is associated with the operation screen.

6. The voice processing system according to claim 2,
wherein when the display processing processor displays a plurality of the operation screens for the same operation target application, the support information presenter presents screen identification information capable of identifying the plurality of the operation screens such that the screen identification information is associated with each of the operation screens.

7. The voice processing system according to claim 2,
wherein the display processing processor displays a plurality of the operation screens for the same operation target application on each of a first display device and a second display device that are connected to be able to communicate with each other through a network, and
the support information presenter presents, on each of the first display device and the second display device, screen identification information capable of identifying the plurality of the operation screens such that the screen identification information is associated with each of the operation screens.

8. The voice processing system according to claim 2, further comprising:
an operation receiver that receives a predetermined operation executed by the user,
wherein when the operation receiver receives, from the user, an operation for requesting the presentation of the operation support information, the support information presenter presents the operation support information.

9. The voice processing system according to claim 2,
wherein when the voice receiver receives the voice of the user, the support information presenter presents the operation support information.

10. A voice processing method that executes a predetermined command based on a voice of a user and that is executed by one or a plurality of processors, the voice processing method comprising:
displaying an operation screen for an operation target application serving as a target to be operated by the user;
presenting operation support information for the operation target application such that the operation support information is associated with the operation screen;
receiving the voice of the user;
identifying, based on the voice received in the receiving of the voice, a first command for the operation target application; and
executing, on the operation target application, the first command identified in the identifying of the first command.

11. A non-transitory computer-readable recording medium that records a voice processing program which executes a predetermined command based on a voice of a user,
wherein the recording medium records the voice processing program for instructing one or a plurality of processors to execute:
displaying an operation screen for an operation target application serving as a target to be operated by the user;
presenting operation support information for the operation target application such that the operation support information is associated with the operation screen;
receiving the voice of the user;
identifying, based on the voice received in the receiving of the voice, a first command for the operation target application; and
executing, on the operation target application, the first command identified in the identifying of the first command.
